(19) United States
(12) Patent Application Publication
(10) Pub. No.: US 2012/0160621 A1
(43) Pub. Date: Jun. 28, 2012

(54) SUSPENSION SYSTEM FOR A BICYCLE AND DAMPER DEVICE

(75) Inventors: STEFAN BATTLOGG, ST. ANTON I.M. (AT); MARTIN WALTHERT, AARBERG (CH); GERNOT ELSENSOHN, ST. ANTON I.M. (AT); JÜRGEN PÖSEL, BLUDENZ (AT)

(73) Assignee: DT SWISS, INC., GRAND JUNCTION, CO (US)

(21) Appl. No.: 13/336,144

(22) Filed: Dec. 23, 2011

(30) Foreign Application Priority Data
Dec. 23, 2010 (DE) 10 2010 055 830.3

(51) Int. Cl. F16F 9/53

(52) U.S. Cl. 188/267.2

(57) ABSTRACT

A suspension system for a muscle-powered two-wheeled vehicle having a damper device with a first damper chamber and a second damper chamber coupled with one another via a controllable damping valve. A sensor captures data about at least one current state. An electronic control device and a storage device are provided for controlling the damper device. At least one damping characteristic of the damper device can be influenced by a signal from the control device. The damping valve has a field generating device assigned to it which serves to generate and control a field strength in a damping channel of the damping valve. A field-sensitive rheological medium is provided in the damping channel for controlling the damping characteristic of the damper device in dependence on the sensor data.

### CROSS-REFERENCE TO RELATED APPLICATION

This application claims the priority, under 35 U.S.C. §119, of German patent application DE 10 2010 055 830.3, filed Dec. 23, 2011; the prior application is herewith incorporated by reference in its entirety.

### BACKGROUND OF THE INVENTION

### Field of the Invention

The present invention relates to a suspension control or a suspension system for an at least partially muscle-powered two-wheeled vehicle and in particular a bicycle comprising at least one damper device for damping shocks.

Bicycle dampers have become known in the art which serve for the damping of shocks. U.S. Patent Application Publication No. US 2009/0192673 A1 describes a bicycle with a controllable damper. The damper comprises an adjustable valve wherein the valve aperture size is controlled by an electric motor. Such a system is operational in principle. A drawback of the prior art system is, however, the adjustment of the passage aperture of the valve by an electric motor since these kinds of motor-controlled components are error-prone.

### SUMMARY OF THE INVENTION

It is accordingly an object of the invention to provide a suspension system which overcome the above-mentioned disadvantages of the heretofore-known devices and methods of this general type and which provides for a suspension system for an at least partially muscle-powered two-wheeled or multiple-wheeled vehicle which can control the damping characteristic without requiring motor-activated components.

With the foregoing and other objects in view there is provided, in accordance with the invention, a suspension system for an, at least partly muscle-powered, vehicle, such as a two-wheeled vehicle. The suspension system comprises:

at least one damper device formed with a first damper chamber and at least one second damper chamber coupled with one another via at least one controllable damping valve;

a sensor disposed to detect data about a current state;

an electrical control device connected to the sensor and a memory device, the control device outputting a control signal controlling, and influencing a damping characteristic of, the damper device;

the damping valve having at least one damping channel and a field generating device associated therewith for generating a field and controlling a field strength in the at least one damping channel of the damping valve; and

a field-sensitive rheological medium in the damping channel for controlling the damping characteristic of the damper device in dependence on the data detected by the sensor.

A suspension control or a suspension system according to the invention is provided to be employed in at least partially muscle-powered bi- or multi-cycles and comprises at least one damper device having a first damper chamber and at least one second damper chamber.

The first damper chamber and the second damper chamber are coupled with one another via at least one controllable damping valve. At least one sensor is provided for capturing data about at least one current state. Furthermore an electric control device and a storage device for controlling the damper device are provided, such that at least one damping characteristic of the damper device can be influenced by a signal from the control device. Advantageously the damping valve has a field generating device assigned to it which serves to generate and control a field strength in the at least one damping channel of the damping valve. In the damping channel at least one field-sensitive, rheological medium is provided for controlling the damping characteristic of the damper device in dependence on the sensor data.

The suspension system according to the invention has many advantages. A considerable advantage of the suspension system according to the invention is that a controllable damping valve is employed in the damper device and that the damping valve operates without requiring any motor-activated components. On the whole the intentional or controlled influencing of the flow through the damper valve does not require any moving parts. Changes or adjustments can be effected contactless by means of the field generating device.

For varying the damping properties of the damper device the field generating device generates a defined field strength in at least one damping channel of the damping valve in which a rheological medium is present which reacts sensitively to the field applied. Applying a field changes the rheological properties of the medium and in particular the viscosity of the field-sensitive rheological medium changes. Such a field allows a simple way of varying the flow capacity of the damping channel to a considerable extent without employing motor-activated components so as to provide a flexible damper device which is adjustable as needed.

Such a suspension system allows to store in the storage device characteristics for the damper device which can be retrieved by the control device. This allows the setting of a wide variety of damping characteristics in the same damper device using simple means.

Employing a field generating device which generates a field in the damping channel as needed allows safe operation of a suspension system which is more durable and less error-prone. Another advantage is the considerable response speed since the intended field intensity is applied virtually instantly by means of the field generating device. This allows very rapid control of the damping valve which shows properties variable in real time.

It is in particular also possible to control the properties of the damping valve in dependence on the current sensor signal. The present invention does not require actuation of a motor which by means of motion changes the size of a valve aperture for influencing the damping characteristics. The field generating device does not even have to be provided immediately next to the damping channel but it may be disposed remote therefrom if field-conductive materials are provided to ensure the intended field strength in the damping channel.

The damping valve properties can be controlled or else regulated. The properties of the damping valve may be controlled or regulated actively or passively in dependence on the current signal of at least one sensor. In the sense of the present invention the term control also includes regulation in preferred more specific embodiments. Such regulation may be active or passive.

The particularly preferred rheological medium employed is a magneto-rheological medium and in particular a magneto-rheological fluid. Oil or the like can for example be employed containing magneto-rheological particles. These magneto-rheological particles virtually form chains along the field lines of an applied magnetic field such that the viscosity transverse to the field lines of an applied magnetic field is considerably higher than it would be with no magnetic field applied. The intensity and strength of the magnetic field influences the resulting viscosity accordingly. The response speed is very high. A magneto-rheological field responds for example within about 1 or 2 ms, changing the viscosity in dependence on the field applied.

The invention allows to adapt a wide variety of damper device parameters to the current conditions and the current wishes of the user.

In particular is it possible and preferred to preset or pre-program the damping characteristics at the factory. Calibration and recalibration are also possible.

The suspension system may be employed in a bicycle and likewise in other muscle-powered unicycles or multi-cycles, including those equipped with an auxiliary drive such as an electro-assist.

The invention may comprise a damper device as a front wheel damper or else a damper device as a rear wheel damper. It is likewise possible and preferred to equip a bicycle with a front wheel damper and a rear wheel damper and to jointly control both dampers by means of the suspension system according to the invention. This allows a particularly well adjusted operation particularly oriented at the wishes of the user. Another damper may be provided additionally for example at the seat post.

For example an adjustment or a switch may be provided for converting the suspension system from a sporty damping setting to a comfortable damping setting. It is also possible to virtually switch off the damper device to reduce as far as possible or to entirely eliminate the damper device effects on smooth roads or the like.

It is possible for the damping valve to be provided with different channels or damping channels for the compression stage and the rebound stage each of which can then be controlled separately. Or else it is possible for the damping valve to comprise a channel or multiple channels which the field generating device can always activate jointly with the flow through the damping valve being controlled in real time for both the compression stage and the rebound stage such that the desired flow-through conditions prevail at all times.

Preferably the field generating device comprises at least one electric coil for generating a magnetic field. It is also possible and preferred for at least one field generating device to be configured as a permanent magnet. It is possible for the magnetic field of the coil to dynamically superimpose the magnetic field of the permanent magnet for setting any desired field strengths.

It is particularly preferred for the field strength of the permanent magnet to be variable at any desired time as often as desired such that the field strength setting remains permanently set. The setting of the field strength of the permanent magnet may in particular be adjustable by way of at least one magnetic pulse to any desired value between zero and remanence. Preferably the magnetic pulse can be generated by the electric coil.

This configuration is particularly advantageous since a permanent magnet used as the field generating device permanently maintains its field strength without constantly requiring an electric current. A permanent magnet once magnetized at a specific field strength generates a constant magnetic field for long periods of minutes, hours or days and thus virtually forever such that the damping characteristics of the damping valve remain constant even without any further energy supply. When such a permanent magnet is re-magnetized by appropriate magnetic pulses of an electric coil, then the permanent magnet shows a field strength that is in particular randomly adjustable, lying as defined between zero and the maximum field strength predetermined by the remanence.

When for example in a ride on cobblestones or the like a specific damping characteristic is required for an extended period then the permanent magnet can be set to the desired field strength by way of a magnetic pulse of the electric coil, whereupon the permanent magnet permanently maintains its newly set field strength until it is changed next and thus the damper device of the suspension system retains its conditions thus set, requiring no further energy supply. Remagnetizing to a higher or lower field strength level is possible at any time by way of brief magnetic pulses of the electric coil such that arbitrary control of the damping characteristics of the damper device is possible. Such a configuration offers high operability while requiring little energy.

A suitable sequence of an attenuating, alternating magnetic field allows to intentionally attenuate or bring to zero the field strength of the permanent magnet. The polarity of magnetization can likewise be changed.

It is likewise possible to generate a static magnetic field with the permanent magnet which can be superimposed by a dynamic magnetic field of the coil without thereby involving a permanent influence on the static magnetic field. Such a dynamic influence on the static magnetic field of the permanent magnet allows to generate a desired field strength.

Preferably the permanent magnet consists of a hard-magnetic material at least in part. The permanent magnet is in particular at least made of such a material and is structured such that a magnetic flux density of at least 0.3 tesla and in particular of at least 0.5 tesla can be generated in the damping channel.

The permanent magnet consists at least in part of a material having a coercitive field strength of above 1 kA/m and in particular above 5 kA/m and preferably above 10 kA/m. Preferably the permanent magnet consists of a material having a coercitive field strength of less than

1000 kA/m and preferably less than 500 kA/m and particularly preferably less than 200 kA/m.

Preferably at least one energy storage device is provided. While such an energy storage device may be configured as a capacitor device, it may be a conventional accumulator which is for example present in an e-bike at any rate.

Generally, damper devices for bicycles seek to obtain a good, ergonomic response reaction. One aspect thereof is a zero passage of the force and velocity progression. This means that an idle piston will start moving already under small or minuscule forces. A zero passage of the characteristic damper curve is very advantageous for a homogeneous transition from the compression to the rebound stage.

U.S. Pat. No. 6,131,709 and its counterpart European patent No. EP 1 034 383 B1 show an adjustable valve and a vibration damper for a bicycle wherein no such homogeneous transition from the compression to the rebound stage is achieved. U.S. Pat. No. 6,131,709 employs a permanent magnet for generating a magnetic field. Mechanical adjustment means serve to adjust the strength of the magnetic field which is effective on the passageway filled with a magneto-rheological fluid. The magnetic field strength is set by varying the distance of the magnet from the passageway. As the distance increases, the field strength in the passageway decreases. In this way the magnetic field strength in the passageway is adjusted such that it directly influences the strength of the chain formation of the individual particles in the magneto-rheological fluid.

It is a drawback in the system according to U.S. Pat. No. 6,131,709 that in operation a specific breakaway force must first be overcome until the magneto-rheological fluid flows through the damping channel since the magnetic field generated by the permanent magnet causes a specific chain formation of the magneto-rheological particles in the passageway. This means that no damping will occur in the case of minor shocks. Damping will only occur with shocks being higher than the breakaway force. The response reaction of damping is thus poor since only large shocks will be damped. In fact the magnitude of the breakaway force can be adjusted via the strength of the magnetic field by way of increasing the distance of the permanent magnet from the gap to reduce the effective field, or by way of approaching the permanent magnet further towards the gap to increase the effective field. The drawback of this is, however, that the position of the permanent magnet must be changed for each desired strength of a shock from which the damper is intended to start operating. Shocks having smaller breakaway moments are not damped. In the case of shocks having larger breakaway moments the passageway opens and the shock is damped according to the field strength.

To achieve a particularly ergonomic response reaction the damping channel and/or the field generating device of at least one damper device can be structured such that the damping channel can over its cross-section be exposed to a field which is in particular intentionally inhomogeneous.

Preferably the damper device is provided with at least one adjusting device with which to adjust the field effective in the or in at least one of the damping channel(s).

By means of the adjusting device one can particularly preferably adjust at least a portion of the cross-section of the damping channel that is exposed to a field of a specific strength such that only part of the cross-section of the damping channel can be exposed to a field of a specific strength.

By means of the adjusting device one can in particular adjust at least a portion of the cross-sectional area of the damping channel that is exposed to a field of a specific and in particular predetermined strength such that the cross-sectional area of the damping channel can be exposed to a field of a specific strength in part only.

In this way a zero passage of the force—velocity progression is achieved. The damping channel is virtually subdivided in a transition section and optionally a bypass section.

By means of the adjusting device one can in particular adjust at least a portion of the cross-sectional area of the damping channel that is exposed to a field of a specific and in particular predetermined strength. In this way only part of the cross-sectional area of the damping channel can optionally be exposed to a field of a specific strength.

It is also possible for the volume portion of the damping channel on which a field of a specific strength acts to be adjustable by means of the adjusting device.

In particular does the damping channel comprise at least one effective section exposed to the field and/or a bypass section that is not at all or hardly at all exposed to the field wherein at least one transition region is adjacent to the effective section and/or the bypass section wherein at least the transition region is preferably adjustable.

One considerable advantage of a suspension system having such a damper device is that the cross-section of the damping channel does not need to be entirely and wholly exposed to a specific magnetic and/or also electric field but it is possible to expose only a fixed or variable portion of the cross-section of the damping channel to the field. This may for example occur in that the gap size exposed to the field is adjusted via the adjusting device or else fixedly predetermined. The field generating device and/or the damping channel may be configured to be adjustable relative to one another. The inhomogeneity of the field is utilized.

This virtually results in a quasi partitioning of the damping channel and in a simple case into a trisected gap of the damping channel having three different effective regions:

One effective section or effective area of the cross-section is exposed to the full field, a transition section of the cross-section is exposed to a sub-field only and one part of the cross-section namely, the bypass section, is not at all or hardly at all exposed to the field.

Partitioning occurs in particular without any separate channels or partition walls into sections or regions, not mechanically but preferably by way of the magnetic field only. This also holds for the bypass section that is formed by part of the cross-section of the damping channel.

Partitioning the cross-section of the damping channel occurs by way of a locally inhomogeneous field which has a low or very low strength in the bypass section and a high or higher strength in the effective section. Between the bypass section and the effective section in particular the transition section is provided which is configured to be highly inhomogeneous over its cross-sectional portion and over which the field strength increases from the lower value of the bypass section to the higher value of the effective section.

Preferably the field strength is rather constant over the cross-sectional portion of the effective section. Preferably the field strength is again rather constant over the cross-sectional portion of the bypass section. In the transition section the field strength is highly inhomogeneous, increasing from the low value in the bypass section to the high value in the effective section.

The at least one bypass section acts as a bypass channel, resulting in a zero passage of the characteristic damper device curve. Due to the variable cross-sectional size of the bypass channel the gradient of the characteristic damper curve can be adjusted as desired.

The transition section is only exposed to a sub-field which is in particular inhomogeneous—the attenuating edge field (stray field)—in which the chain formation of the particles is weak, continuously attenuating towards the edge. The transition section remains closed in the case of weak loads. In the case of weak loads, the sub-field virtually closes the transition section. In the case of weak loads or weak shocks, only the set bypass section will determine the current operating point on the characteristic damper curve. The set bypass section fines the characteristic damper curve in the case of weak loads.

With increasing loads due to higher piston forces or piston velocity the flow of the damping fluid through the bypass section entrains the particles that are partially or weakly chained with one another firstly over a portion in the adjacent transition section.

Furthermore, as loads increase, the shearing forces will exceed beyond the bonding forces of the chained particles. The flow cross-section of the bypass section consequently increases with increasing loads and the cross-sectional area of the closed transition section decreases correspondingly. In this way a non-linear damper response is realized. The transition section of the characteristic damper curve from the low-speed section to the high-speed section becomes curved and an ergonomically adverse break point is reliably avoided. A characteristic damper curve can be generated that is continuous and asymptotic towards

both ends.

This results in many various options since for example a virtually non-influenced gap width in the damping channel is continuously variable, quasi-continuously, or in specific increments. For example the damping channel cross-sectional area substantially non-influenced by a field can be adjustable in 5%, 10%, 20%, 25%, or 33% increments to expose to the magnetic field a corresponding portion of the cross-sectional area of the damping channel in two, three or more increments.

By means of an adjusting device one can preferably adjust the area portion of the cross-section of the damping channel on which a field of a specific strength is effective. The area portion of the damping channel that is not influenced by the field virtually acts as a bypass such that by means of the field the cross-sectional area effective for weak shocks is correspondingly reduced while for shocks exceeding the breakaway force of the fluid that is exposed to the field and influenceable by a field, the entire cross-sectional area of the damping channel is employed for damping.

It is also conceivable that in addition to or else instead of the area portion, the volume portion of the damping channel is adjustable on which the field of specific strength acts.

Preferably the adjusting device can be automatically controlled by the control device.

A mean value of a field strength or a total mean value may be determined over the entire cross-section of the damping channel. The field is inhomogeneous over the cross-section of the damping channel. By way of an adjusting device that cross-section portion may be set in which the field is stronger or weaker than the total mean value of the field strength.

In particular can the proportion be set of the maximum field strength and minimum field strength concurrently acting on the damping channel, while the area portion in which an above-average strength magnetic field is effected can be set as well. Preferably the area portion is adjustable over which the magnetic field is inhomogeneous, decreasing from maximum field strength to minimum field strength.

The adjusting device may comprise at least one longitudinally displaceable adjusting member and/or at least one rotary device. The rotary device in particular comprises at least one rotary unit for adjusting at least one damping channel for the rebound stage and/or a rotary unit for adjusting at least one damping channel for the compression stage. The rotary units may be configured coaxially.

The control device may for example, via generating an electric or specific magnetic field, lead to rotation of a rotary unit whereby the portion of the bypass section or the transition section is adjustable.

For moving the rotary unit or the rotary units a motor may be provided configured e.g. as a servo motor. By way of such a motor component acting on the damping channel indirectly only the motor component is only exposed to minor loads which allow an enduring, trouble-free function. It is not the size of the damping channel that is influenced but the field acting on the damping channel is changed for example by way of rotating the field generating device.

The adjusting device in particular acts on the field in the damping channel via mechanical adjustment or movement.

It is also possible and preferred to realize the adjusting device without any moving parts. For example the damping valve of a damper device may comprise two or more field generating devices which can be activated separately. When a first field generating device acts on one side of the damping channel and a second field generating device on a second and in particular opposite side of the damping channel. Then a strong field can act on a first side while on the second side the field of the second field generating device superimposes and neutralizes the field of the first field generating device. In this way a highly inhomogeneous field is generated over the damping channel wherein the strength of the field and the strength of inhomogeneity can be adjusted. Also conceivable are more than two field generating devices so as to allow a still more improved fine adjustment of the field intensity over the cross-section of the damping channel. Individual field generating devices may be realized as an adjustable permanent magnet or as an electric coil.

It is conceivable for the field generating device to comprise multiple pairs of poles for generating a magnetic field such that multiple transition regions can be generated in the damping channel.

In all of the configurations the damper piston may be sealed towards the housing wall by means of a permanent magnet wherein the permanent magnet field causes a local chain-formation of the magneto-rheological fluid and thus causes reliable sealing between the exterior of the piston and the race of the piston at the housing wall. Preferably the energy storage device provides at least the electric energy for operation during short rides. The energy storage device is advantageously dimensioned such that its weight and/or its dimensions are not significantly impeding in operation as intended. In the case of bicycles with a dynamo and in particular a hub dynamo or the like the required power may be picked off the dynamo and optionally the use of a larger energy storage may be dispensed with.

In preferred embodiments at least one GPS sensor is provided. It is for example possible for maps to be stored in the storage device also containing altitude data other than two-dimensional data. As a location is determined by means of a GPS sensor, the geographical altitude is specified as well. Or else it is conceivable for the GPS signal to be analyzed not only in respect of the local resolution on the earth's surface but in respect of the altitude as well. Analyzing a GPS signal offers many advantages since for example in lap rides or in repeated rides over a specific stretch the GPS signal provides the current location at the time and thus allows to utilize data previously stored about the quality of the stretch of road.

It is for example also possible to utilize previously stored settings of the damper device by way of the location data of a GPS sensor such that the damper characteristics of the damper device are controlled in the same way as in a preceding lap. Preferably data directly input or an internet network connection or a radio connection allow to utilize previously stored settings of other users.

Or else it is possible to draw conclusions about the further run of the route by way of the GPS data and by way of maps and to promptly set the damper device accordingly. It is for example possible to analyze the altitude data of the GPS sensor or of the stored maps such that if uphill rides are identified the damper device is set accordingly. For example a suspension fork can be automatically lowered for specific inclines, thus facilitating uphill rides. For downhill rides in turn suitable damping characteristics can be automatically activated such as telescoping the damper if the damper had previously been retracted for example for an uphill ride.

It is also possible and preferred to utilize data about the quality of the currently used road stored during previous tours and the damper device is operated with automatic control by way of the data stored in the storage device. Such an operating mode allows a very anticipatory operation in which the damper device is always adapted to the currently prevailing conditions.

Other than using GPS sensors or the like a distance measuring device or an odometer or the like may be utilized for determining the local position. A measuring instrument for the distance traveled allows high precision when determining the position on a previously stored route. It is also conceivable to utilize cell data e.g. of mobile telecommunications or data transmission networks to obtain information about the current position.

It is also possible and preferred to employ at least one camera or stereo camera capturing for example the ground just in front of the bicycle and directly determining the ground characteristics via image analysis, setting the damper accordingly.

The control device may be provided at or else in the damper device. It is likewise possible for the control device to be disposed separately.

It is also possible and preferred to provide in the damper device a control unit which is in data connection with a separately disposed control device at least temporarily. Each of the components such as suspension fork, rear wheel damper and optionally seat post may comprise their own control units such that they are then connected with one another and/or with the control device at least temporarily.

Such a configuration allows a central (bicycle) computer for overall control while the control unit provided in the damper device performs control locally. For example if a rear wheel damper and a suspension fork are provided, both of these components can each comprise a local control unit for local control. Overall control may be provided by the separate control device which is accommodated for example in the control computer, bicycle computer, or in a mart phone or the like. Data exchanges between components may be provided through wire connection or else wireless.

It is a considerable advantage of a magneto-rheological medium that magneto-rheological particles response to an applied field very rapidly and in the range of one millisecond so as to allow to set the desired characteristic of the damper virtually at no significant time delay.

Preferably at least part of the permanent magnet is disposed adjacent to the coil and/or surrounded by the coil to ensure a maximum effect of the field strength of the coil.

In all of the configurations it is possible for at least one damping channel to be divided into at least two sub-channels by at least one partition wall. These sub-channels extend at least in part in particular transverse to the magnetic field lines to once again reinforce the effect.

It is preferred for the first damper chamber and the second damper chamber to be disposed at least in part in one shared damper housing. Separate housings are conceivable as well. Then they are preferably separated from one another by at least one damper piston which damper piston may have at least one damping channel at its exterior. It is also possible for at least one damping channel to pass through the damper piston.

In preferred embodiments it is possible to set the spring hardness e.g. by additionally activated spring chambers and to adjust suspension travel. An additionally activated spring chamber may be provided external of or within the damper housing.

Additionally to GPS sensors other sensors may be employed for example for measuring and analyzing the velocity of the bicycle and/or capturing the speed or the force on the damper. For example location sensors, inclination sensors, position sensors for the damper piston or status sensors for determining the stroke of the damper device may be provided and their sensor data may be captured and analyzed.

It is possible and preferred to set different modes of the suspension system such as the mode “uphill” or the modes “downhill”, “terrain”, “road” or “lap rides”. The modes “teaching mode” and “repeat mode” are likewise possible. In teaching mode all of the data such as measured data and operator input are stored. In repeat mode the data and pertaining signals are retrieved depending on the current position and the signals are used for controlling the control device without requiring new user input. An “override” function may be provided which allows all operator input even in repeat mode with priority, storing these for the next lap.

The damper device may be provided with sensors for capturing bottoming out or for recognizing the degree of suspension travel.

In all of the cases it is preferred to allow fine tuning at any time by manual user action. Communication between components may be wireless. It is for example possible for an operating device to be disposed at the bicycle handlebar, communicating wirelessly with the rear wheel damper and/or the front wheel fork. It is also possible to transmit the data to the internet where they are stored in a protected or optionally in a public area.

It is also possible and preferred to provide separate, different channels for the compression stage and the rebound stage. Each of the channels may be adjustable separately.

Different channels for high-speed damping and for low-speed damping may be provided.

Furthermore at least one blow-off valve may be provided as a protection from destructive overload. Individual mechanical valves may be equipped with shims for flow control. A purely mechanical lock-out valve may also be provided. Such a lock-out valve may for example be switched by an external lever.

For preferred normal settings a mechanical setting tool in the shape of e.g. an operating lever or an adjusting component or an adjusting screw or the like may be provided.

It has been found difficult to provide the entire dynamic section via one damping channel only.

It is therefore another object to provide a damping device offering a large adjusting range of the damper characteristics by way of simple measures.

With the foregoing and other objects in view there is also provided, in accordance with the invention, a damper device, comprising:

a first damper chamber and at least one second damper chamber coupled with one another via at least one controllable damping valve;

the controllable damping valve having at least one damping channel formed therein containing a field-sensitive rheological medium;

at least one field generating device assigned to the at least one damping valve and serving to generate and control a field strength in the damping channel of the damping valve; and

at least one further, mechanical influencing means configured to influence and flow through the damping valve.

This damper device according to the invention is equipped with a first damper chamber and at least one second damper chamber. The first damper chamber and the second damper chamber are coupled with one another via at least one controllable damping valve. The damping valve comprises at least one damping channel. At least one field-sensitive, rheological medium is provided in the damping channel. The at least one damping valve has at least one field generating device assigned to it which serves to generate and control a field strength in the damping channel of the damping valve. The damping valve comprises at least one other flow channel the flow rate of which can be influenced by mechanical influencing means.

The damper device according to the invention also has many advantages. The at least one additional flow channel allows a particularly easy and efficient control of the damping characteristics of the damper device. This allows separation and coupling of a mechanical influencing means and of an influencing means via the field generating device. The field generating device may optionally be configured simpler and less complicated since one single field generating device does not need to cover the entire dynamics. Task sharing may be provided where the field generating device covers a subsection and the one or more mechanical influencing means cover/s another or multiple other subsection/s.

In particular can at least one flow channel be provided with a mechanical influencing means in series with the damping channel. This allows to achieve via the mechanical influencing means a general flow restriction and via the field generating device, directed modulation of the flow through the damping channel.

Advantageously at least one flow channel is provided in parallel to the damping channel. A controllable bypass may be realized thereby.

In all of the embodiments at least one flow channel may be provided with at least one in particular pre-loaded check valve as the mechanical influencing means. When an additional, parallel flow channel is provided, it can thus be active in a simple way in one flow direction only.

Preferably at least one flow channel may be provided with a pre-loaded shim as the mechanical influencing means. This shim may comprise a plurality of separate, thin plates. At least one flow channel may be provided with an adjustable cross-section. The flow cross-section may be adjusted by measures known in the prior art. The cross-section may for example be adjustable via an adjustable, threaded component as the mechanical influencing means. The threaded component may in particular be screwed into the cross-section of the flow channel to different depths to change the free flow cross-section.

These configurations of a damper device offer considerable advantages since they allow reducing the modulating range to be covered by the field generating device. In case of a lock-out the flow through the damping valve should be virtually entirely blocked. A purely magneto-rheological damping valve requires a strong magnetic field therefore. If the lock-out is realized via an additional, mechanical influencing means in the form of a mechanical adjusting means, then the modulating range of the field generating device or the field strength to be achieved can be considerably reduced without diminishing the function.

Other features which are considered as characteristic for the invention are set forth in the appended claims.

Although the invention is illustrated and described herein as embodied in suspension system for a bicycle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 a schematic illustration of a bicycle with a suspension system according to the invention;

FIG. 2 a schematic illustration of a suspension system;

FIG. 3 a suspension system according to the invention with a schematic illustration of a sectional side view of a damper device in the normal position;

FIG. 4 another sectional side view of the damper device according to FIG. 3;

FIG. 5 the detail A from FIG. 3 in an enlarged illustration;

FIG. 6 the valve of the damper device according to FIG. 3 in an enlarged, perspective illustration;

FIG. 7 a cross-section of the damper device according to FIG. 3;

FIG. 8 a schematic time diagram of the magnetic field strength;

FIG. 9 a schematic illustration of the data in operation in a lap ride;

FIG. 10 a schematic illustration of a damping valve,

FIG. 11 a perspective view of another damper device;

FIG. 12 a section of the damper piston of the damper device according to FIG. 11 in a first position;

FIG. 13 a section of the damper piston of the damper device according to FIG. 11 in a second position; and

FIG. 14 the characteristic curve of the valve according to FIG. 10.

### DETAILED DESCRIPTION OF THE INVENTION

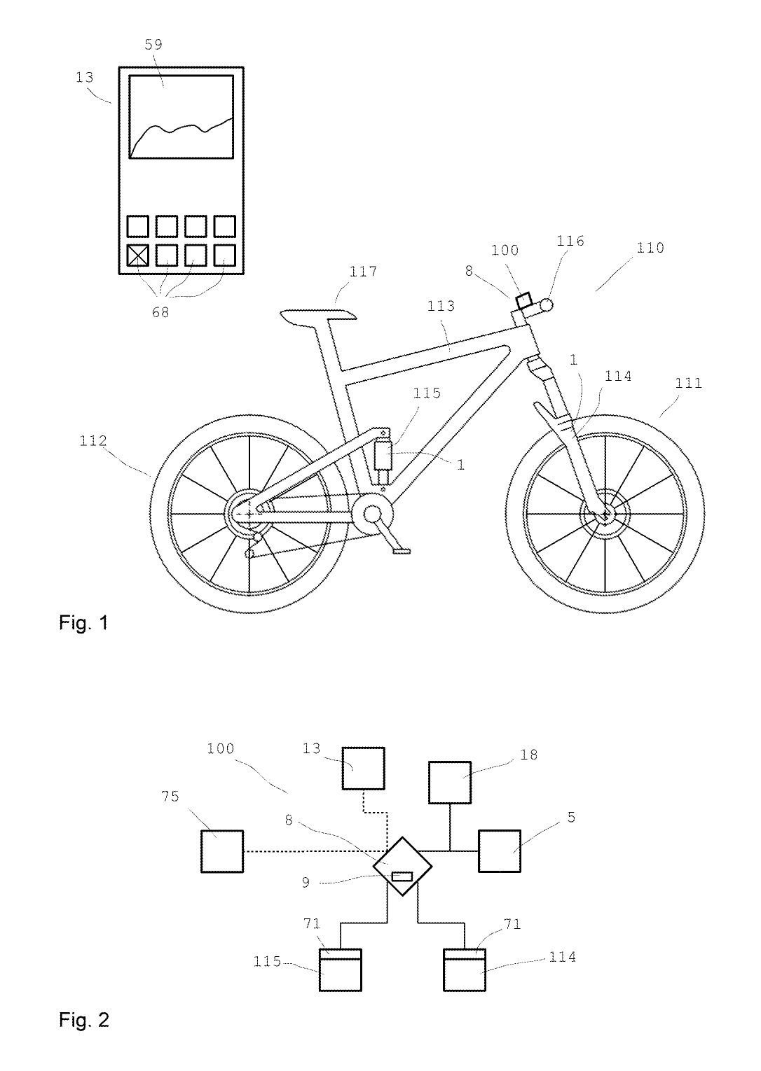

A first embodiment of the invention will be described with reference to FIGS. 1 to 10, showing a suspension system 100 with a damper device 1 for a bicycle.

Referring now to the figures of the drawing in detail and first, particularly, to FIG. 1 thereof, there is shown a schematic illustration of a two-wheeled vehicle, here in the form of a bicycle 110 that is configured as a mountain bike, that is equipped with a suspension control system 100, or suspension system 100, for short. The bicycle 110 comprises a frame 113, a front wheel 111 and a rear wheel 112. Both the front wheel 111 and the rear wheel are equipped with spokes and may be provided with disk brakes. A gear shifting system serves to select the transmission ratio. Furthermore the bicycle 110 comprises a saddle 117 and a handlebar 116.

The front wheel 111 is provided with a damper device 1 configured as a suspension fork 114 and the rear wheel is provided with a damper device 1 configured as a rear wheel damper 115. The suspension system 100 is presently provided at the handlebar 116. The suspension system 100 may be incorporated in one of the damper devices 1 or provided in another location.

By means of the suspension system 100 the damping characteristics of the suspension fork 114 and the rear wheel damper 115 are set in dependence on the currently set riding profile and on the other data supplied to the suspension system or which the suspension system 100 can access. The suspension system 100 controls both the suspension fork 114 and the rear wheel damper 115 and optionally also the suspension and/or damping characteristics of the seat post.

For operation an operating device 13 is provided which may be disposed at the handlebar 116 but may e.g. be configured detachable. Depending on the configuration the control device 8 may be incorporated in the operating device 13 or disposed separately therefrom. The operating device 13 may be provided with a display 59 to provide data about the current operating condition, measured data or other data.

The operating device may for example also serve as a bicycle computer and output data about the current velocity, average velocity, kilometers per day, per tour, per lap and total, and about the current position, current altitude and the distance traveled or the distance still lying ahead. The output of further analyses is conceivable as well.

The operating device 13 which in the illustration according to FIG. 1 is greatly enlarged for better clarity and illustrated remote from the handlebar comprises operating knobs 68 or the like.

FIG. 2 shows a schematic illustration of the suspension system 100 wherein the communication connections of the involved components with the control device 8 are inserted. The operating device 13 is connected with the control device 8 via a

wire or wireless connection presently shown in dotted lines. The connection is not required to be continuous if the control device 8 does not form part of the operating device 13.

Two sensors 5 and 18 are exemplarily inserted whose measured data are transmitted to the control device 8 as data 6. The sensors may supply data about the current road condition, the current inclination or the current loads on the damper devices 1 which are used for automatically controlling the suspension system 100.

When a lap is traveled again, values stored in repeat mode are retrieved from a storage device 9 and the damper devices 1 are set accordingly.

The suspension fork 114 and the rear wheel damper 115 are presently equipped with a local control device 71 each which perform local control of the respective damper device 1. It is likewise possible for the control device 8 to centrally control the damper devices 1. A connection with the internet 75 may be established temporarily, as needed or periodically to store, retrieve, or provide to other persons data 6 in a protected or else in a freely accessible area.

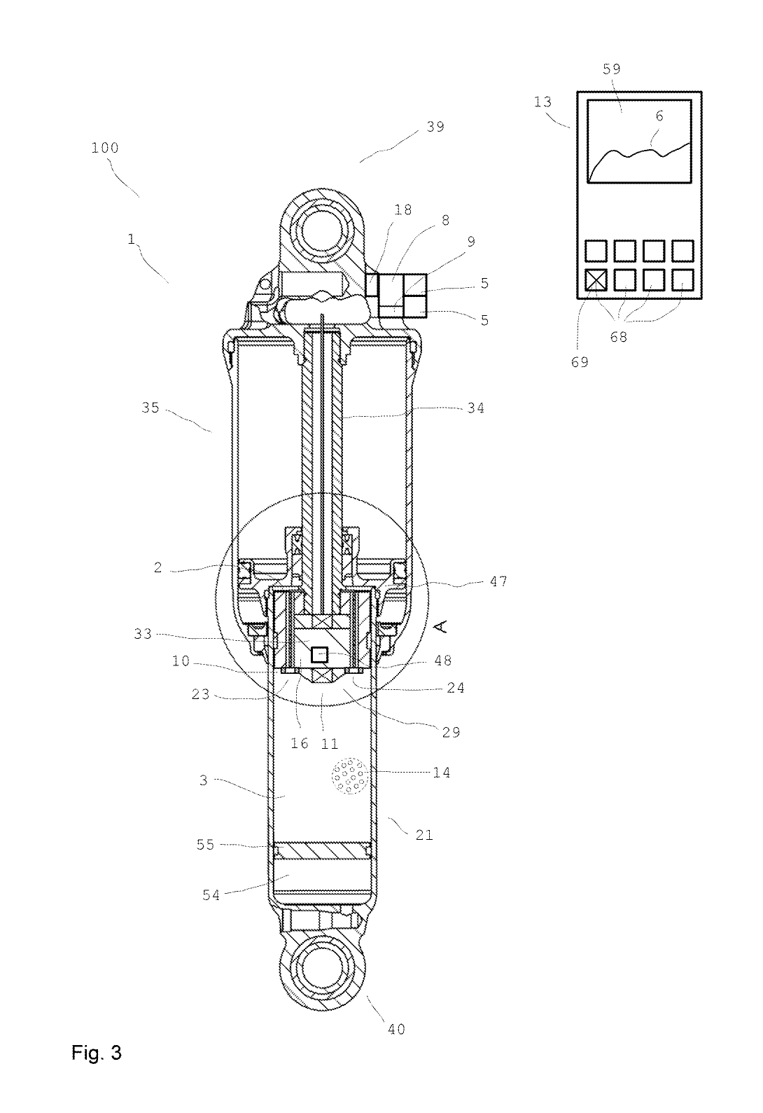

The damper device 1 illustrated in FIG. 3 is configured as a rear wheel damper 115 and comprises a first end 39 and a second end 40 which are indirectly or immediately connected with the frame 113 or the rear wheel 112.

The suspension fork 114 illustrated in FIG. 1 is equipped with a damper device 1. It is also possible to equip a suspension system 100 with one controllable suspension fork 114 only or with one controllable rear wheel damper only.

A suspension system 100 which controls both the suspension fork 114 and the rear wheel damper 115 allows a particularly extensive and optimal control of the riding properties of a bi- or multi-cycle thus equipped. Other than use for purely muscle-powered bicycles, use for bi- or multi-cycles and in particular for electro-assisted bicycles is possible and preferred.

The damper device 1 shown in section in FIG. 3 comprises a damper which presently comprises a first damper chamber 2 and a second damper chamber 3 which are separated from one another by a damper piston 29. Damping channels 23 and 24 are provided in the damper piston 29 as flow connections which presently serve for damping in the compression stage and in the rebound stage.

Both the first damper chamber 2 and the second damper chamber 3 and the damping channels 23 and 24 are presently filled with a rheological medium 14 presently configured as a magneto-rheological fluid containing ferromagnetic particles such as carbonyl ferrous powder in a carrier liquid. The carrier liquid is preferably oil-based with additives such as stabilizers, antifreeze agents, abrasion and viscosity improvers. The rheological medium 14 is illustrated simplistically in FIG. 1 in a detail.

The damper piston 29 presently serves as a valve or damping valve 4 with which to control the flow of the magneto-rheological fluid 14 from the first damper chamber 2 to the second damper chamber 3 via the damping channels 23 and 24. By way of a magnetic field of the field generating device 11 the viscosity of the magneto-rheological fluid in the damping channels 23 and 24 is influenced and with increasing field strength, movement of the piston 29 is damped more. Additionally to influencing via a magnetic field an influencing means 10 is also provided. It is configured as a control disk or the like and can if desired close the damping channels 23 and 24 completely e.g. for realizing a lock-out. To avoid overload with the lock-out activated, shims or the like may be additionally provided to reopen the damping channels in the case of particularly great shocks. The influencing means 10 may be provided rotary and transferable automatically or manually from the closed position to the opened position and vice versa.

A piston rod 34 is located after the damper piston 29, extending through a spring device 35 presently configured as a pneumatic spring. The spring device 35 comprises a first spring chamber 41 and a second spring chamber 42, separated by a piston 47.

The suspension system 100 comprises at any rate an electric or electronic control device 8 which may in particular also be provided with a microprocessor or a microcomputer. The control device 8 may comprise a storage device 9 in which data, control programs, program routines, control data, measured data, data about the bicycle and the damper devices 1 employed, and personal user data.

The control device 8 may be provided with a communication device such as a modem or a wire-bound or wireless interface or an independent internet connection via special or standardized interfaces and radio connections.

As shown in FIG. 2, control may be done locally or centrally.

At least one sensor 5 for capturing data is assigned to the control device 8. These data 6 may for example comprise position data 61 of a GPS sensor 18 stored in the storage device 9 with the associated time stamp. Data from a sensor 48 for capturing the field strength of the magnetic field of the field generating device 11 may also be captured, processed, and stored.

The data 6 captured furthermore include measured data about the current state 7 or the operating state. For example data about the current compression or rebound state can be captured. The data about the state 7 may in particular include or represent data about the position of the bicycle or else include data about the road conditions.

Capturing and storing operating data 60, terrain data 62, data about the strength of shocks, about the compression or rebound state of the damper device 1 are also preferred as the data 6. Preferably data about the bicycle speed, optionally the weight of the bicycle and the rider are also stored in the storage device 9.

An operating device 13 is provided for operation. A data connection of the operating device 13 with the damper device 1 exists at least temporarily.

The operating device 13 may comprise buttons or control knobs 68 for operating and at least one display 59 for outputting visual information. Operation is also possible by the touch panel since the display 59 is configured as a touch-sensitive surface which may, other than presses, movements and the like, in particular identify points. Optical or capacitive recognition of user actions is also possible. The display 59 may output the time curve of captured data 6 or of signals 50 to allow the user a direct analysis.

The operating device 13 may be provided with interfaces for transferring data and programs. The interfaces may operate via wire or wireless such that wire-bound and/or wireless data connections are possible. Other than specific connection types, connections via serial, parallel, or network interfaces are likewise possible. Both the operating device 13 and the control device 8 may optionally establish connections and exchange data via infrared, Bluetooth, Wireless Lan, GPRS, UMTS, ANT+ Ethernet, glass fiber and the like. The operating device 13 used may possibly be a handheld or other computer or a mobile telephone or the like. Such an apparatus may run a program for general control.

It is likewise possible for the control device 8 to be disposed in or assigned to the operating device 13. While the operating device 13 does not require continuous contact with the damper device 1 or the control device 8, the control device should at any rate when in operation be in continuous contact with the damper device 1.

The first end 39 may be provided with a manual adjusting organ e.g. for making general changes to the spring characteristics or for specifying normal settings. The adjusting organ may e.g. comprise rotary parts as the adjusting elements. Preferably the current settings as well as the normal settings are controlled via the control device 8.

The storage device 9 is preferably provided with a non-volatile memory for permanent storage of control and user data even without current supply.

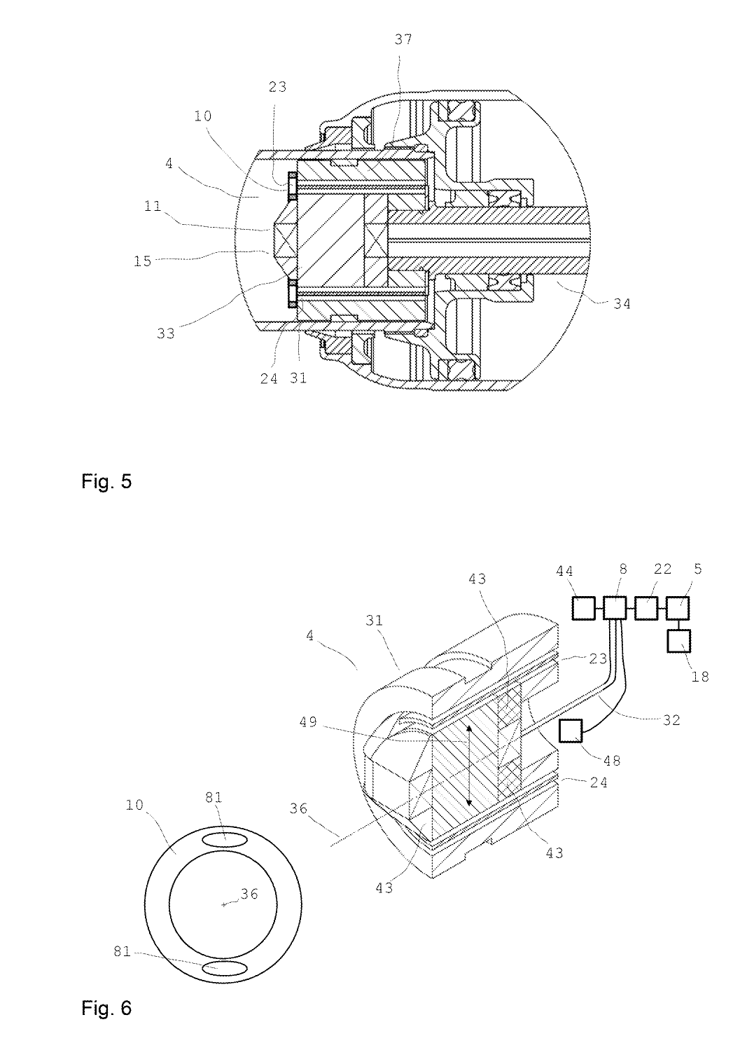

The end of the central piston rod 34 is provided with the damper piston 29 which comprises a field generating device 11. The field generating device 11 may comprise at least one electric coil 15 and at least one permanent magnet 16. The permanent magnet 16 may comprise at least one core 33 (see FIG. 5).

For sealing the damper piston 18 in the damper housing 17 a piston ring may be provided as a sealing. Or else it is conceivable for the magnetic field of the field generating device 11 to cause complete sealing from the damper housing 17 since the magnetic field of the field generating device 11 or another magnetic field causes chain-forming of the particles in the magneto-rheological fluid such that sufficient sealing may be effected.

The core 33 of the permanent magnet 16 is enveloped in a coil 15 as the field generating device 11. The core 33 consists at least in part of a hard magnetic material having a coercitive field strength higher than 1000 A/m and in particular higher than 10000 A/m. Presently the core 33 consists entirely of alnico which has a high coercitive field strength and is very temperature resistant. It is an advantage for only one or some parts of the core to be hard magnetic to cut down on the magnetization steps required.

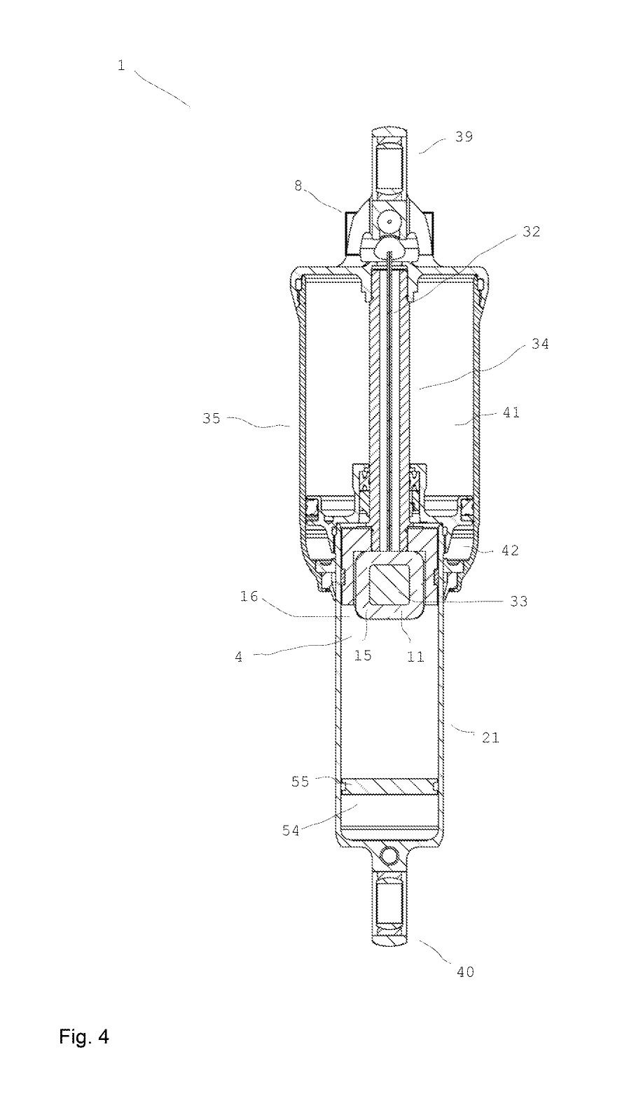

FIG. 4 illustrates a longitudinal section of the damper device 1 wherein the present longitudinal section is perpendicular to the illustration according to FIG. 1.

One can clearly see in the illustration according to FIG. 2 by the damper piston 29 configured as a valve or damping valve 4 how the electric coil 15 envelops the hard magnetic core 33 of the permanent magnet 16. In this way it is ensured that as the electric coil 15 generates a magnetic pulse 17, a maximum effect on the hard magnetic core 33 is generated so as to achieve reliable setting and changing of the field strength 19 of the permanent magnet 16.

The electric lines 32 for control and energy transmission are clearly recognizable in the illustration according to FIG. 2. By means of the lines 32 the energy required for the electric coil 15 is supplied and control is effected. Optionally it is also possible for the control device 8 to be provided within the damper device 1 such that the lines 21 serve for energy supply only.

The differential spring 54 is typically filled with a gas and is separated from the damper chamber 3 through a floating piston 55. The differential spring 54 serves to equalize the volume when the piston rod 34 dips into the damper housing 21 since then the entire volume available to the magneto-rheological fluid 14 is reduced due to the inserted portion of the piston rod 34.

FIG. 5 shows an enlarged illustration of the detail A from FIG. 3.

One can clearly recognize the damping channels 23 and 24 by means of which the flow connection is made available between the first damper chamber 2 and the second damper chamber 3.

The valve 4 presently configured as a damper piston 29 comprises centrally in the middle the core 33 of a hard magnetic material which is enveloped on all sides in an electric coil 15.

The front faces of the core 33 are provided with the damping channels 23 and 24. Finally the core 33 is radially enveloped in a ring conductor 37 which consists of a magnetically conductive material. Preferably the ring conductor 37 consists of a soft magnetic material. Optionally it may at least in part consist of a hard magnetic material.

By way of the ring conductor 37 the magnetic field of the permanent magnet 16 with the hard magnetic core 33 is closed. The field lines of the magnetic field run transverse to the damping channels 23 and 24 to thus allow to achieve a maximum effect on the magneto-rheological fluid 14.

The drawing shows an embodiment variant in which the damping channels 23 and 24 and the ring conductor 37 extend over the entire piston length while the core 33 is only approximately half the length. The power range of the damper may be adjusted through the length of the damping channels 23 and 24 and through the magnetic field strength. A lock-out may be adjusted via the influencing means 10 wherein the influencing means 10 configured as a control disk or the like with the apertures 81 is rotated away from the damping channels 23 and 24. The advantage of an additional influencing means 10 connected in series is that the maximum field strength 51 of the field generating device 11 may be considerably smaller.

In the illustrated embodiment the field of the core 33 is concentrated in a portion of the damping channels 23 and 24. Other core shapes allow to set other power ranges and characteristic damper curves.

Furthermore a valve or damping valve 4 is illustrated which as the damper telescopes out, closes off part of the damping channels 23 and 24 as needed, thus allowing a differentiation of the rebound and compression stages of the damper. A partition wall 25 allows to subdivide the damping channels 23 or 24 into sub-channels 26 and 27 so as to further enhance efficiency (see also FIG. 5 and the pertaining description). The valve used may for example be a prior art shim having a low spring force.

Separate shims or else one-way valves may provide separate damping in the rebound and in the compression stages. For example one channel 23 may be provided for damping in the rebound stage only and one channel 24, for damping in the compression stage only (or vice versa). One-way valves at the damping channels 23 and 24 then preferably prevent any flow through the corresponding channel in the other of the damping stages. It is also possible to provide two different damping valves 4 one of which damping valves 4 comprises at least

one channel for damping in the rebound stage and one damping valve 4, at least one damping channel for damping in the compression stage. This allows simple, separate control of the damping characteristics in the rebound and compression stages.

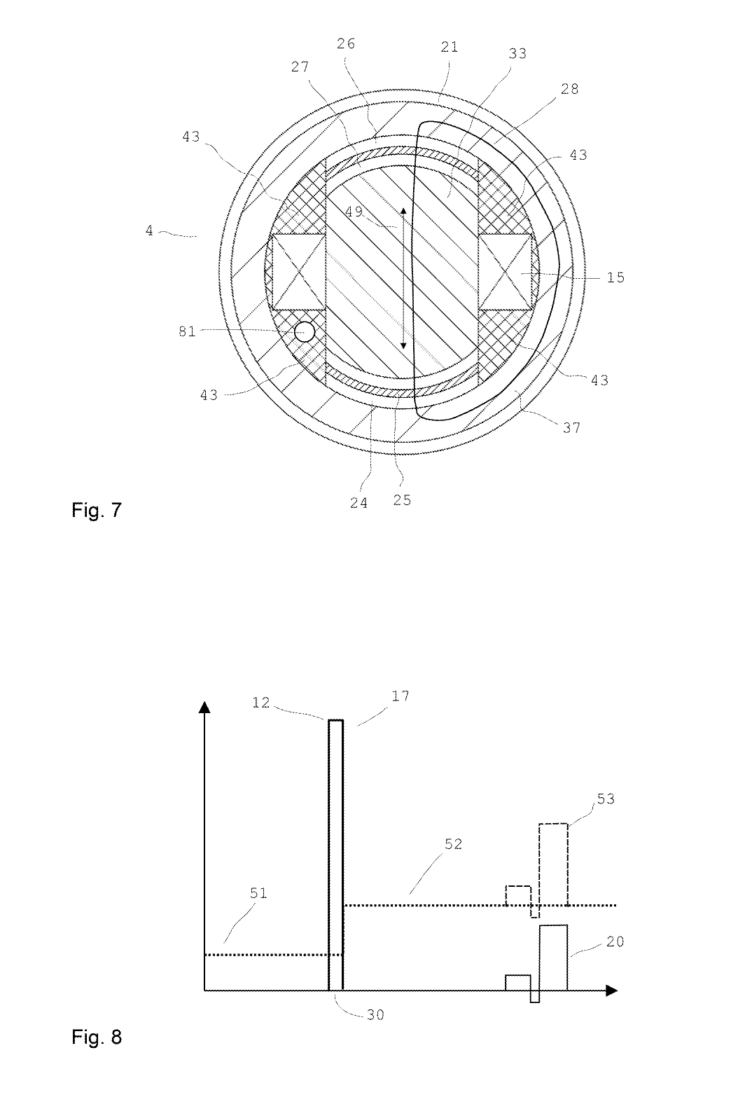

It is furthermore possible to provide at least one separate flow channel 81. Such an additional flow channel 81 may preferably be connected in parallel to the damping channels 23 and 24 and is shown in FIG. 7. Therein the additional flow channel 81 is provided in a region of the isolator 43 such that the cross-section of the flow channel 81 is not at all or only very slightly influenced by a field of the field generating device 11. When the flow channel 81 is provided for a blow-off function, one end of the flow channel 81 is provided with a check valve, a shim or the like which opens automatically as needed. Absent a valve function the flow channel 81 serves as a bypass to achieve a good response reaction.

FIG. 6 illustrates a slightly perspective and sectional illustration of the damping valve 4 wherein the connecting axis 49 of north pole and south pole of the core 33 is indicated in the core 33. For sealing and for directing the magnetic field of the core 33, magnetic isolators 43 are provided in the lateral areas such that the magnetic field generated by the core 33 is not deflected laterally but passes through the damping channels 23 and 24 substantially perpendicularly. Presently the damping channels 23 and 24 run approximately parallel to the longitudinal axis 36 of the damper piston 29. In other configurations the damping channels 23 and 24 may be provided on the exterior 31 of the damper piston 29.

FIG. 4 shows a sensor device drawn schematically which may comprise one or more sensors 5, 18 and 48 etc. Preferably a sensor 48 is provided for detecting the magnetic field strength to determine a measure of the strength of the magnetic field generated by the core 33 in the damping channels 23 and 24. Further sensors are possible such as temperature sensors, viscosity sensors, pressure sensors, travel and acceleration and inclination sensors and the like. The sensor device is connected with the control device 8 for controlling the magnetic pulses emitted through the lines 32.

The electric energy required for a magnetic pulse 17 is provided by an energy storage device 22. An energy storage device 22 such as a capacitor or a battery allows to provide the energy required for a magnetic pulse 17 to achieve magnetization or demagnetization of the core 33 even with a power supply having only low voltage and low power. Power supply is also conceivable by means of an e-bike accumulator, a generator, recuperator, a dynamo or in particular also a hub dynamo.

An oscillator circuit device 44 may be provided to ensure defined demagnetization of the core 33. An attenuating alternating magnetic field is applied to the core 33 to thus achieve demagnetization.

FIG. 5 shows a cross-section of the damper device 1 with the damping valve 4, where for better clarity a field line 28 of the magnetic field generated by the core 33 is inserted.

It can be clearly seen that in the region of the damping channels 23 and 24 the field lines 28 pass through the gap nearly perpendicularly (normal relative to the pole faces). This causes chain formation of the magneto-rheological particles along the field lines 28 so as to achieve maximum damping in the flow direction of the damping channels 23 and 24.

The central core 33 presently consists of alnico as a hard magnetic material and comprises a polarization of north pole in the direction of the south pole along the connecting axis 49. In the direction of the ends of the connecting axis 49 the damping channels 23 and 24 are aligned which are presently configured gap-like and which are once again subdivided by partition walls or fan-like elements 25 in the direction of the gap width so as to obtain sub-channels 26 and 27 at the damping channels 23 and 24.

The partition wall 25 preferably consists of a good magnetic conductor such that the partition wall only represents low magnetic resistance. Optionally the partition walls 25 may consist of a hard magnetic material and be magnetized permanently—though changeably—by the magnetic pulses 17 of the coil 15.

On both sides of the core 33 one can see in the illustration according to FIG. 7 the coil 15 which wholly envelops the core 33. The sides are additionally provided with magnetic isolators 43 which in these regions much reduce the strength of the magnetic field present there since the magnetic field lines follow the smallest resistance, extending through the core 33 and the ring conductor 37.

In preferred configurations the cross-sectional areas of the damping channels 23 and 24 may be additionally adjustable for example by way of mechanical adjustment.

The damping valve 4 is presently formed by the ring conductor 37, the core 33 received therein, the coil 15 and the magnetic isolators 43, and the damping channels 23 and 24 and the additional flow channel 81.

In the presently illustrated embodiment the damping valve 4 is disposed longitudinally displaceably in the damper housing 21 as the damper piston 29.

It is advantageous to manufacture of alnico only that portion of the permanent magnet 16 that is required to allow maintaining a specific field strength and flow density. For example only a portion of the core 33 may be of alnico and the remainder may consist of another ferromagnetic material.

Or else it is conceivable to manufacture the entire permanent magnet 16 of a material having hard magnetic properties. For example if in FIG. 7 the core 33 and the ring conductor 37 are manufactured for the most part of a hard magnetic material, then its coercitive field strength may be smaller than with only part of the core 33 consisting of a hard magnetic material.

FIG. 8 shows the operating principle in changing or setting a desired magnetic field strength 19 from a first magnetic field strength 51 to another magnetic field strength 52. What is shown is the strength of the magnetic field 19 over time wherein the field strength of the core 51 is shown in a dotted line while the magnetic field 12 generated by the electric coil 15 is drawn in a solid line.

It is clearly recognizable that the magnetic field strength 12 generated by the electric coil 15 is zero over most of the time since a magnetic field generated by the electric coil 15 is not required for normal operation and thus no electric energy is required there.

A magnetic field 12 generated by the electric coil 15 is required only if a change of the magnetic field strength of the magnetic device 16 is sought.

Thus the magnetic field strength 51 generated by the permanent magnet 16 firstly has a lower value until a magnetic pulse 17 is triggered by the electric coil 15, wherein the magnetic field strength 12 generated by the electric coil 15 has a corresponding strength to permanently magnetize the hard magnetic core 33 at a corresponding strength.

For example the magnetic field strength of the permanent magnet 16 may be increased from an initially lower field strength 51 to a correspondingly higher field strength 52 to cause a more intense damping or to close the damping valve 4.

While the pulse length 30 for the magnetic pulse 17 is very short and may lie in the range of a few milliseconds, the permanent magnet 16 subsequently has the permanent, high field strength 52 which, given a corresponding magnetic field strength 12 of the magnetic pulse 17, may extend until saturation of the hard magnetic material used. The magnetic field strength 12 generated by the coil 15 during the magnetic pulse 17 causes a permanent change of the magnetic field strength of the magnet 16 from an initial magnetic field strength 51 to a magnetic field strength 52.

In FIG. 8 one can see that the amount of energy saved over a conventional system continuously requiring current depends on the frequency of remagnetizations. However, even in the case of frequent remagnetization, for example once every second, the current requirement is lower than in a similar prior art damper. When remagnetization is activated only as needed, for example as road conditions change, the advantage over other systems becomes much clearer still.

When the core 33 is magnetized to a correspondingly lower level, a correspondingly weak magnetic field 19 is generated. Demagnetization can be generated—as described above—by way of an attenuating alternating magnetic field.

Furthermore FIG. 8 schematically shows on the right in the diagram a situation in which the coil 15 is also used for time-based modification of the active magnetic field 53. When the coil 15 is only subjected to a magnetic field 20 that is weak and e.g. variable over time, as shown on the right in FIG. 8 in a solid line, then the magnetic field 53 active on the whole is influenced correspondingly and is intensified or attenuated, depending on the polarization. This also enables a dynamic influence on the active magnetic field 53 without changing the permanent magnetization of the permanent magnet 16 (field strength 52).

It is also conceivable to employ two or more electric coils in conjunction with corresponding cores.

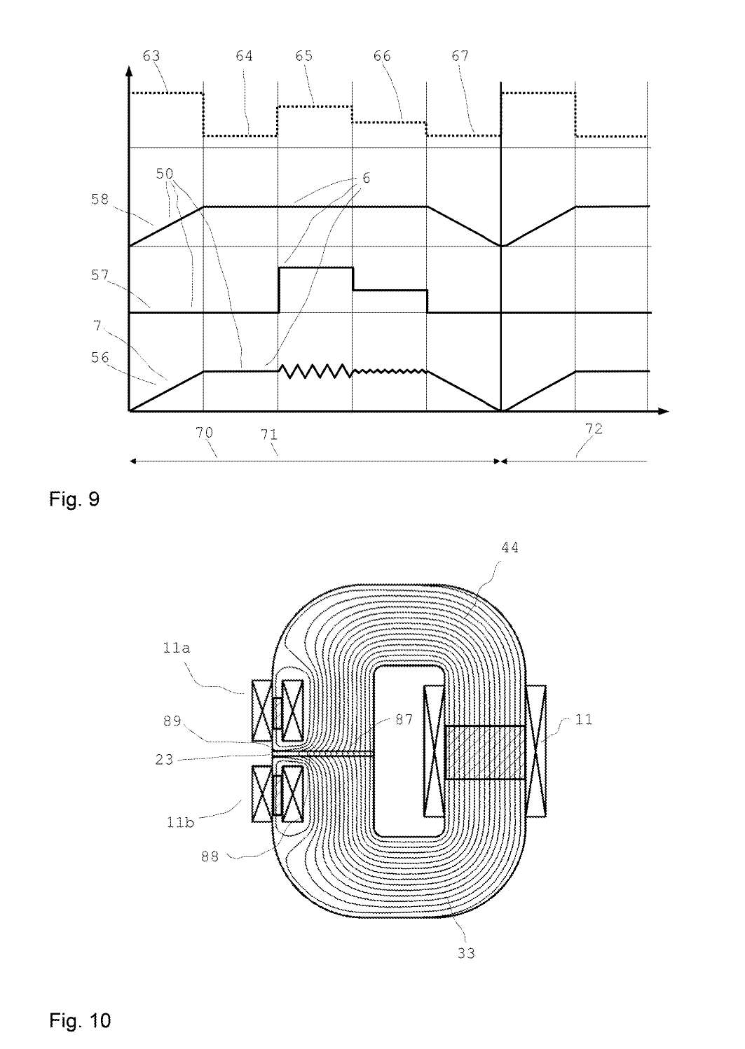

FIG. 9 shows a schematic diagram of different data 6 and signals 50 over a traveled distance 70. The present traveled distance 70 consists of a first lap 71 and part of an illustrated lap 72. In a first run the control device 8 can in a “teaching mode” capture and store data 6 and emitted signals 50. This also includes the signals 50 by which the damping device 1 or the damping valve 4 are controlled. The operating data 60 are stored as well.

The stored data 6 can be retrieved when running a second lap 72 and the damping device 1 may be controlled in analogy to the first lap without requiring user input at the operating device 13.

In teaching mode all of the data such as measured data and operator input are stored. In repeat mode the data and pertaining signals 50 are retrieved depending on the current position and the signals 50 are employed for controlling the control device 13 without requiring new user input. An “override” function may be provided which even in repeat mode allows, and prioritizes, all of the operator input, storing these for the next lap. The laps 71 and 72 do not have to be traveled immediately successively. It is likewise possible for lap 71 to be traveled on one day and the lap 72 at a later time on the same day or on another day.

It is also possible and preferred for the stored data of a lap 71 to be transmitted to another suspension system 100 where they serve as the basis for control. For example the manufacturer, clubs or private individuals may store data including pertaining signals 50 and provide them for third persons.

In FIG. 9 different curves are specifically shown over the traveled distance 70. The bottom curve 56 for example shows a simplistic altitude profile of the traveled distance 70. The distance starts with a climb, followed by a flat, plane stretch. This is followed by a stretch involving heavy jolts and finally a stretch involving slight jolts before a slope follows and the starting point is reached again and lap 72 begins.

The curve 57 schematically shows the intensity of jolts over the run of the road. One can clearly recognize the heavy-jolt stretch on the road section involving a high mean jolt intensity. The smaller-jolt stretch shows a section of medium jolt intensity. In what is presently just a simplistic view no relevant jolts are inserted or recognizable in the area of the climb, the plane stretch, and the slope.

The curve 58 illustrates the altitude data of the GPS sensor 18 which determines the current altitude either directly or derives the altitude data from map data stored in the memory via the determined local position. By way of the curve 58 the control device 8 can detect climbs or slopes. In conjunction with maps with an altitude profile stored or accessible via a data line advance conclusions are possible about the length of a climb or a slope if the intended route is known.

After a ride or after a predetermined or selectable time interval or else directly upon command an analysis of the states of the spring and suspension system can be carried out. When it is found for example that the full suspension travel was not used at all or only rarely then the control device can automatically emit the recommendation to decrease the spring hardness of the system. Reversely an increase of the spring hardness or else of the suspension may be recommended.

During rides, many different parameters may be captured and stored. Storage is in particular possible of data or curves about the stroke of the damper device, the traveling speed, accelerations in the traveling directions and perpendicular or transverse thereto, and about the inclination of the ground, the quantity and respective positions of changes to the damping characteristics, and about the pedaling frequency, the current transmission ratios of the shifting system, the heart rate of the user, etc.

For example if the suspension system by way of the pedaling frequency, the quantity and strengths of damping, the current speed, and by way of climbs and optionally of the heart rate of the user, draws the conclusion that the user is tired, a higher damping may be set to allow the user a more comfortable ride. This may be the case for example if the traveling speed is low while a relatively high heart rate is present although the terrain is plane and the road surface is smooth. Conversely, in the case of high traveling speeds in a plane terrain the conclusion of a good road surface is possible even without analyzing the damping processes such that damping can be adjusted accordingly.

The speed profile allows conclusions about the current riding situation. When a stretch is traveled once or on a regular basis at a high speed, the user will be in training or in a race, such that the suspension system adjusts conditions accordingly. Now if the user travels the same stretch slowly another time, the user is for example riding home relaxed after finishing the training lap, where other damping characteristics may make more sense or be simply more comfortable.

The curve with the signals 63 to 67 shows the signals 50 which the control device 8 emits. The individual signals 63 to 67 can then be automatically determined by the control device 8 or entered by the user. Automatic determining may be based on previously stored data 6.

Presently the signal 63 is emitted which for example causes a lockout of the damper device 1 to avoid what is unnecessary damping in the gradient of the first stretch. At the same time the signal 63 may cause compression of a suspension fork as the damping device 1 to allow the user a more comfortable sitting position in a steep uphill ride.

The signal 63 may be emitted on the basis of a corresponding user input or based on automatically captured values. For example when the suspension system 100 by means of the GPS sensor 18 identifies the gradient and the degree and length of the incline via stored map data or a previously traveled lap 71, then the signal 63 may be emitted automatically for lockout or blocking the damper device 1 optionally with concurrent lowering of the front wheel fork.

Prior to automatic changes to the damper settings the control device 8 may optionally emit an optical and/or acoustic and/or other type of signal so as to not surprise the user with changes such as lowering a suspension fork.

It is also preferred for in particular major changes to the damping characteristics to be carried out only upon confirmation e.g. by pressing a knob or upon acoustic confirmation by the rider. Major changes include in particular lowering a suspension fork since this results in a different riding position.

In the plane stretch section the signal 64 is emitted which presently only causes minor damping. What is also possible in particular in plane stretches without particular jolt loads, continues to be intense damping or locking the damper device 1.

In the following stronger-jolt stretch a signal 65 is emitted which presently causes more intense damping. Subsequently the signal 66 is emitted having low damping in the minor-jolt stretch. In the sloping stretch the signal 67 is emitted for a still weaker damping by the user or automatically.

In all of the cases an automatic generating of signals 63 to 67 on the basis of the other sensor-captured data 6 is preferred. The intensity and type of damping may in particular also depend on the selected operation or operating mode. Manual operation may be possible at any time.

In all of the configurations it is preferred in the case of a low energy level to set predefined properties in good time. When the available remaining energy in the storage device falls below a predetermined level, such as 5% or 10%, a warning signal may be emitted and/or automatic switching to predefined or set emergency running properties or normal properties occurs. This allows to ensure that a return ride or continued ride with reasonable normal settings is always possible. In the

case of another, in particular higher threshold of e.g. 10%, 5%, 20% or 25%, switching over to an energy saving mode is possible in which settings requiring less energy are made. In damper devices having remanence properties the number of remagnetizations per unit time may be reduced. It is likewise possible to limit the number of intermediate stages.

The energy store 22 may be provided rechargeable and in particular exchangeable. This allows to adapt the size, capacity and thus also the weight of the energy store 22 to the desired conditions. In racing or competition conditions a precisely fitted energy store 22 is employed. For day trips it may be chosen larger than for short trips. E-bikes basically have energy already available such that a separate energy store 22 can be dispensed with.

It is possible and preferred for a (basic) calibration to be done by the manufacturer. Fine calibration may be done by the team or the club or the local bicycle dealer. In the scope of maintenance, reset and re-calibration can be done.

FIG. 10 illustrates a damper device 1 in which three different field generating devices 11, 11a and 11b are provided. Each of the field generating devices 11, 11a and 11b may comprise one permanent magnet and one electric coil. The remaining structure of the damper device 1 may be identical to the structure in FIG. 3.

The three different and intentionally variable field generating devices 11, 11a and 11b allow a still wider variety of adapting the damping properties. Different adjustments of each of the respective magnetizations allow a wide variety of settings for the damping channels 23 and 24.

The sum of the individual fields of the field generating devices 11, 11a and 11b amounts to a total field which flows through the damping channel 23 respectively 24. The shape of the field influences the characteristic damper curve 65. The field generating device 11 presently determines the normal strength of the field 51. The field generating devices 11a and 11b can influence the field in the damping channel 23 or 24 respectively.

When the polarization of the field generating devices 11a and 11b is the same as that of the field generating device 11, then the magnetic field in the damping channel 23 is homogeneous, its strength depending on the magnetization of all of the field generating devices. When the polarization of the field generating devices 11a and 11b is inverse that of the field generating device 11, then an inhomogeneous magnetic field is formed in the damping channel 23.

Different sections are formed such as an effective section 87 with the maximum field strength, a transition section 88 with a sharply dropping field strength, and a bypass section 89 with virtually no or only very minimal field strength. The shape of the sections depends on the magnetization of each of the field generating devices and may be adjusted over a wide range. Or else it is possible to polarize the two field generating devices 11a and 11b in opposite senses wherein one of these is polarized the same as the field generating device 11. In this way the adjusting range of the damper device 1 may be enlarged further.

The gap width of the damping channel 23 is considerably less than is the gap length, the ratio of gap length to gap width exceeding the factor 2 and being in particular higher than 5 or even higher than 10.

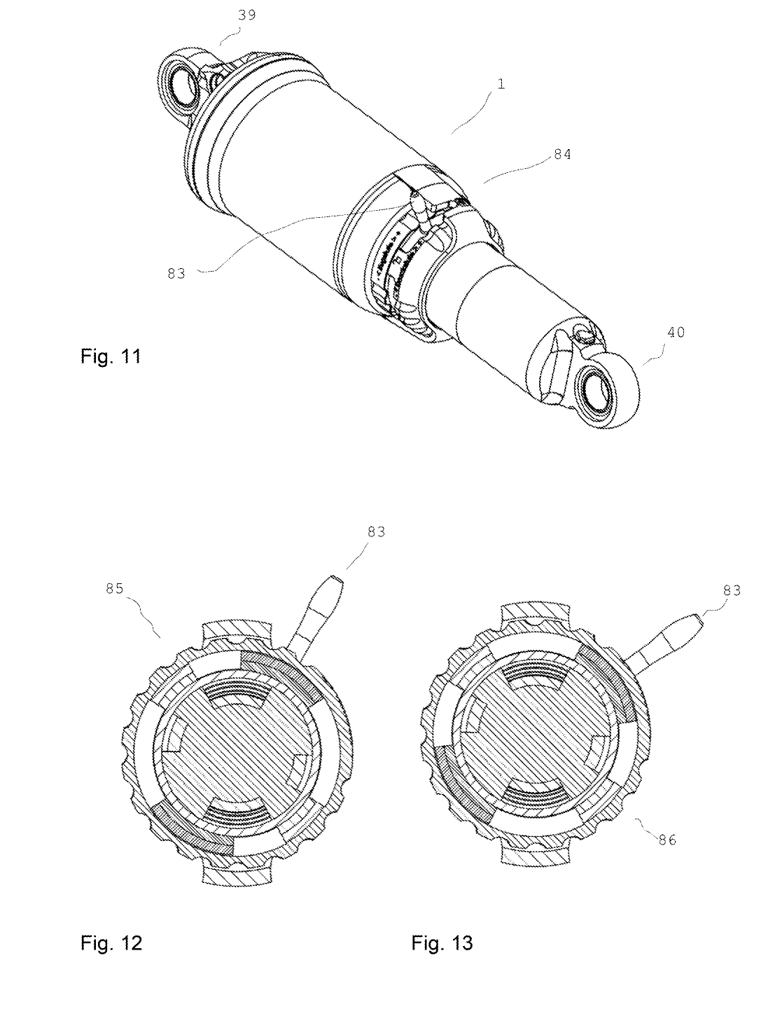

In FIG. 11 a perspective view of another damper device 1 is illustrated which is basically provided with the same functions as the damper device in FIG. 10. In this way the damper device 1 can be controlled by a control device 8 in dependence on data 6 from sensors 5. Additionally a mechanical operating lever 83 is provided which can be shifted from the first position 84 illustrated in FIG. 11 via the position 85 illustrated in FIG. 12 to the third position 86 illustrated in FIG. 13. Intermediate positions are possible.

Shifting the operating lever 83 adjusts the proportion of the damping channels 23 and 24 which are exposed to a magnetic field of a specific strength. The cross-section of the damping channels 23 and 24 can in turn be subdivided into three sections namely, an effective section 87, a transition section 88, and a bypass section 89. Selecting a position 84, 85 or 86 allows to select the ratios of the sizes of the sections 87 to 89 relative to one another. In the position 86 the bypass section is largest, and in position 84, smallest in size.

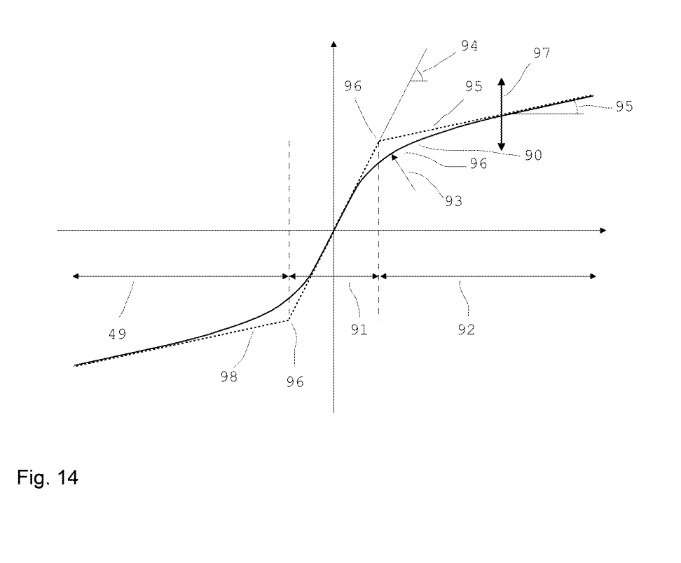

FIG. 14 shows a characteristic damper curve 90 of the damper device 1 according to FIG.

10 with the damping valve 4 in a force-speed diagram of the damper piston. The low-speed section 91 and the high-speed section 92 are connected with a radius 93 through a gentle rounding. The characteristic curve is presently structured symmetrically, showing the same curve for the rebound and the compression stages. Basically though, different curves of the two stages are possible and desired.

Basically the characteristic curve of the damper device 1 according to the FIGS. 11 to 13 also corresponds to the characteristic curve 90. Variations are achieved by way of the size of the bypass section 89 and the transition section 88 and of the locking section or effective section 87.

In the damper device 1 according to FIG. 10 the gradient 94 of the characteristic damper curve in the low-speed section 91 is substantially determined by the bypass section 89. In the high-speed section 92 the gradient 95 is substantially determined by the cross-section of the entire damping channel 23 or 24 and the strength of the field in the effective section 87.

In the transition section 88 over the extension of which an attenuating magnetic field is effective, the advantageous, non-linear contour leads to the rounding which leads to a comfortable and safe operation.

What is also drawn in is an arrow 97 showing the effect of a magnetic field having different strengths. Given a stronger magnetic field, the characteristic curve will shift upwardly while with a weaker magnetic field it will shift downwardly.

Dotted lines show a characteristic damper curve 98 which would be present without any transition section 88 if, other than the magneto-rheological damping channel 23 or 24, an additional damping channel 81 is provided as the bypass channel.

The gradient in the low-speed section 94 is adjustable by means of the portion of the bypass section 89. The larger the bypass section 89, the smaller the gradient. The zero passage is also generated by the bypass section 89 since damping fluid can at any time flow through the bypass section 89 without being influenced such that damper piston movement will be triggered already by weak forces.

The gradient in the high-speed section 95 is influenced by the shape of the entire damping channel 23 and 24 and the set strength of the magnetic field 52 in the effective section 87.

The area with the rounding which is significant for comfort and safety is rounded by way of the transition section 88 of the damping channel 23 or 24 so as to enable an ergonomic and safe operation. The size of the rounded area follows from the size and shape of the transition section 88 which can be flexibly adjusted by corresponding adjustment of the strength of the magnetic fields of the field generating devices 11, 11a and 11b. Power supply by means of a generator, dynamo or in particular a hub dynamo is conceivable as well.

The invention provides an advantageous suspension system which may comprise one, two, or more dampers. By way of storing the data and later retrieval, data may be exchanged and made available to friends, club pals, and quite generally other persons. In this way every user can test, compare, and check their own personal riding style. Inexperienced users may resort to proven values on known distances. Experts and professionals may try out experimental settings and feel their way to the optimum. The gained experiences may for example be exchanged in clubs or in particular in internet forums. Exchanging experiences gained with specific settings will result in understanding.

This specification describes and claims an invention that is related, in some respects to our copending, concurrently filed patent application Attorney Docket No. XBSB-804P12, which is herewith incorporated by reference in its entirety.

1. A suspension system for an, at least partly muscle-powered, vehicle, the suspension system comprising:
at least one damper device formed with a first damper chamber and at least one second damper chamber coupled with one another via at least one controllable damping valve;
a sensor disposed to detect data about a current state;
an electrical control device connected to said sensor and a memory device, said control device outputting a control signal controlling, and influencing a damping characteristic of, said damper device;
said damping valve having at least one damping channel and a field generating device associated therewith for generating a field and controlling a field strength in said at least one damping channel of said damping valve; and
a field-sensitive rheological medium in said damping channel for controlling the damping characteristic of said damper device in dependence on the data detected by said sensor.

2. The suspension system according to claim 1, wherein said field generating device comprises at least one electric coil for generating a magnetic field.

3. The suspension system according to claim 1, wherein said field generating device includes a permanent magnet whose field strength can be set by way of a magnetic pulse to a random value between zero and remanence.

4. The suspension system according to claim 3, wherein said field generating device comprises at least one electric coil for generating the magnetic pulse.

5. The suspension system according to claim 3, wherein said permanent magnet consists at least in part of a material selected from a group of materials consisting of AlNiCo, CuNiFe, FeCrCo, FeCoVCr, SmCo, NdFeB, FeCr, FeCoVCr, neodymium, and materials having comparable magnetic properties.

6. The suspension system according to claim 1, which further comprises at least one electric energy storage device.

7. The suspension system according to claim 3, which further comprises at least one electric energy storage device configured to provide electric energy for generating at least one magnetic pulse.

8. The suspension system according to claim 1, which comprises at least one GPS sensor.

9. The suspension system according to claim 1, wherein said sensor is at least one sensor for capturing shocks on said damping device and/or for capturing a road surface condition and/or for capturing an operating state of the vehicle.

10. The suspension system according to claim 1, which comprises at least one operating device configured to enable different modes to be selected.

11. The suspension system according to claim 3, wherein at least a part of said permanent magnet is disposed adjacent to said coil or surrounded by said coil.

12. The suspension system according to claim 1, which comprises at least one partition wall dividing said damping channel into at least two sub-channels.

13. The suspension system according to claim 12, wherein said sub-channels extend transversely to magnetic field lines of a magnetic field generated by said field-generating device.

14. The suspension system according to claim 1, wherein said first damper chamber and said second damper chamber are disposed in one common damper housing at least in part and separated from one another by way of at least one damper piston.

15. The suspension system according to claim 1, wherein said damping channel and said field generating device are configured such that said damping channel can be exposed to an inhomogeneous field over a cross-section thereof.

16. The suspension system according to claim 1, which comprises at least one adjusting device for adjusting the field effective in said damping channel.

17. The suspension system according to claim 16, wherein said adjusting device is configured adjust at least a portion of a cross-section of said damping channel that is exposed to a field of a specific strength such that the cross-section of said damping channel can be exposed to a field of a specific strength in part only.

18. A damper device, comprising:
a first damper chamber and at least one second damper chamber coupled with one another via at least one controllable damping valve;
said controllable damping valve having at least one damping channel formed therein containing a field-sensitive rheological medium;
at least one field generating device assigned to said at least one damping valve and serving to generate and control a field strength in said damping channel of said damping valve; and
at least one further, mechanical influencing means configured to influence and flow through said damping valve.

19. The damper device according to claim 18, wherein at least one flow channel is provided in parallel to said damping channel.

20. The damper device according to claim 18, wherein at least one flow channel is provided with a pre-biased check valve.

21. The damper device according to claim 18, wherein at least one flow channel is provided with a pre-loaded shim.

22. The damper device according to claim 18, wherein at least one flow channel is provided with an adjustable cross-section.

23. The damper device according to claim 22, which comprises an adjustable threaded component for adjusting the cross-section of said at least one flow channel.
